(19) United States
(12) Patent Application Publication
(10) Pub. No.: US 2024/0388041 A1
(43) Pub. Date: Nov. 21, 2024

(54) SHIELD UNIT

(71) Applicant: Yazaki Corporation, Tokyo (JP)

(72) Inventor: Kouichirou MATSUSHITA, Shizuoka (JP)

(73) Assignee: Yazaki Corporation, Tokyo (JP)

(21) Appl. No.: 18/784,108

(22) Filed: Jul. 25, 2024

Related U.S. Application Data
(63) Continuation of application No. PCT/JP2023/009139, filed on Mar. 9, 2023.

(30) Foreign Application Priority Data
Mar. 22, 2022 (JP) 2022-045655

(51) Int. Cl. H01R 13/6592; H01R 9/05

(52) U.S. Cl. CPC H01R 13/6592; H01R 9/0518

(57) ABSTRACT

A shield unit includes: an coaxial wire including an internal wire, a wire shield covering an outer periphery of the internal wire, and an outer skin covering an outer periphery of the wire shield; a sleeve assembled to a terminal where the wire shield is exposed from the outer skin, and having an outer periphery covered with a folded-back part of the wire shield which is folded back; and a shield member having a shield crimping part which is crimped to the outer periphery of the folded-back part. The shield member includes an outer skin crimping part which is disposed on the coaxial wire side from the shield crimping part, and crimped to the outer periphery of the outer skin. The sleeve includes an abutment part which abuts on the outer skin crimping part when the coaxial wire and the shield member move in the direction separated from each other.

### CROSS-REFERENCE TO RELATED APPLICATIONS

The present application is a continuation of International Application No. PCT/JP2023/009139, filed on Mar. 9, 2023, and based upon and claims the benefit of priority from Japanese Patent Application No. 2022-045655, filed on Mar. 22, 2022, the entire contents of which are incorporated herein by reference.

### TECHNICAL FIELD

The present disclosure relates to a shield unit.

### BACKGROUND ART

JP 2012-48818 A (PTL 1) discloses a shield unit including a shield cable as a coaxial electric wire, in which the shield cable includes a signal wire as an internal electric wire, a braid as an electric wire shield covering an outer periphery of the signal wire, and a sheath as an outer skin covering an outer periphery of the braid. The shield unit further includes a sleeve assembled to a terminal part where the braid is exposed from the sheath of the shield cable, and in which an outer periphery is covered with a braid inversed part of the braid as a folded-back part which is folded back. The shield unit further includes an outer conductor terminal as a shield member having a pair of barrels as a shield crimping part crimped to an outer periphery of the braid inversed part of the braid.

In this shield unit, when a pair of barrels is crimped to the outer periphery of the braid inversed part of the braid, the braid inversed part is interposed between the pair of barrels and the sleeve. When the pair of barrels and the braid inversed part come into contact with each other, the braid of the shield cable and the outer conductor terminal are electrically connected to each other.

### SUMMARY

Meanwhile, in the shield unit of PTL 1, for example, when a pulling force is applied to the coaxial electric wire, the coaxial electric wire and the shield member may move in a direction separated from each other. When the coaxial electric wire and the shield member move in the direction separated from each other, the position of the shield crimping part which crimps the electric wire shield may deviate, which may deteriorate the electrical connection reliability between the electric wire shield and the shield member.

An object of the present disclosure is to provide a shield unit capable of securing an electrical connection reliability.

A shield unit according to an embodiment includes: a coaxial electric wire including an internal electric wire, an electric wire shield covering an outer periphery of the internal electric wire, and an outer skin covering an outer periphery of the electric wire shield; a sleeve assembled to a terminal part where the electric wire shield is exposed from the outer skin of the coaxial electric wire, and having an outer periphery covered with a folded-back part of the electric wire shield which is folded back; and a shield member having a shield crimping part which is crimped to an outer periphery of the folded-back part of the electric wire shield. The shield member is provided with an outer skin crimping part which is disposed on a coaxial electric wire side from the shield crimping part, and crimped to an outer periphery of the outer skin of the coaxial electric wire. The sleeve is provided with an abutment part which abuts on the outer skin crimping part when the coaxial electric wire and the shield member move in a direction separated from each other.

The above configuration makes it possible to provide a shield unit capable of securing an electrical connection reliability.

### BRIEF DESCRIPTION OF THE DRAWINGS

FIG. 1 is a perspective view of a shield unit according to a present embodiment.

FIG. 2 is an exploded perspective view of the shield unit according to the present embodiment.

FIG. 3 is a cross-sectional view of the shield unit according to the present embodiment.

FIG. 4 is a cross-sectional view of a connector according to the present embodiment.

FIG. 5 is a perspective view of a housing and a spacer of the connector according to the present embodiment.

### DETAILED DESCRIPTION

Hereinafter, a shield unit according to a present embodiment will be described in detail with reference to the drawings.

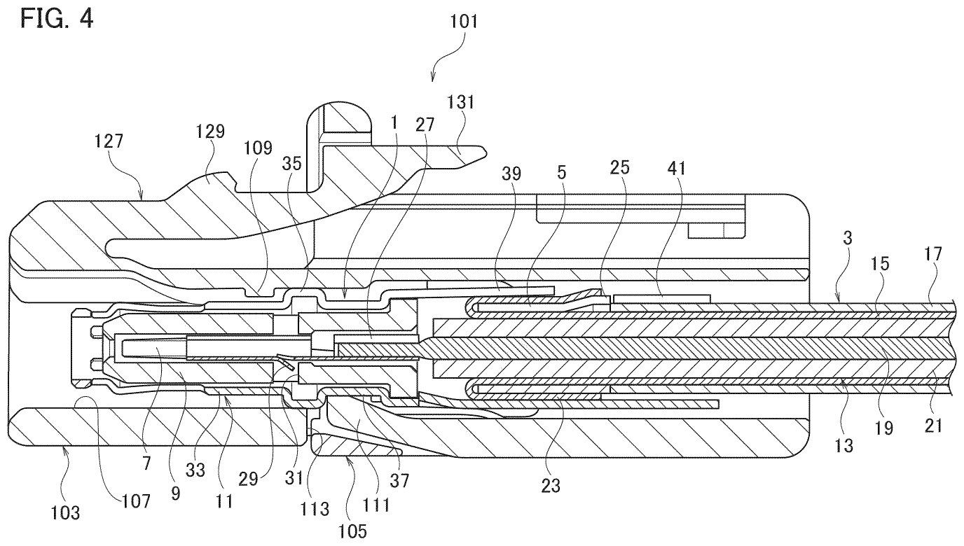

As illustrated in FIG. 4, a shield unit 1 according to the present embodiment is applied to, for example, a connector 101 that can be fitted with a mating connector (not illustrated). For example, the mating connector houses a mating terminal (not illustrated) electrically connected to a power source, a device, or the like, and a grounded mating shield member (not illustrated). When the mating connector is fitted with the connector 101, the mating terminal and the terminal 7 are electrically connected to each other, and thus the mating shield member and a shield member 11 are electrically connected to each other.

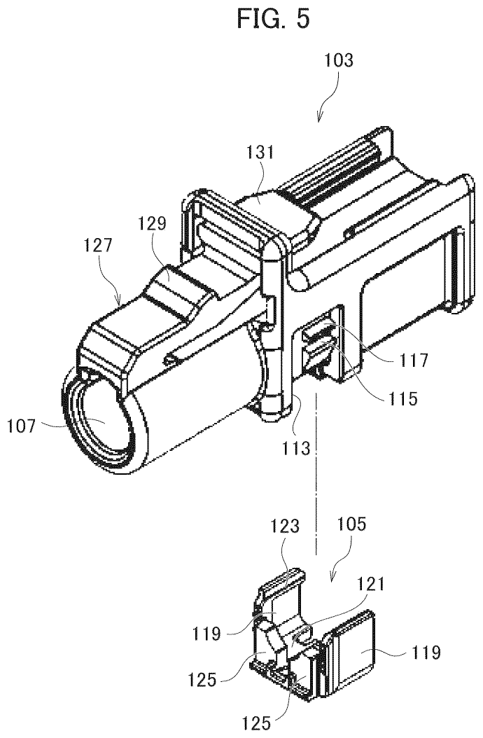

As illustrated in FIGS. 4 and 5, the connector 101 includes a housing 103, a spacer 105, and the shield unit 1.

The housing 103 is made of an insulating material such as a synthetic resin. The housing 103 is formed into a housing shape extending in the direction in which the connector 101 and the mating connector are fitted together. A housing chamber 107 capable of housing the shield unit 1 is provided within the housing 103.

The housing chamber 107 extends along the direction in which the connector 101 and the mating connector are fitted together. An engagement projection 109, which is formed in such a way as to project inward, is provided within the housing chamber 107. The engagement projection 109 engages with (abuts on) the shield unit 1 to position the shield unit 1 relative to the housing chamber 107. A locking lance 111 is provided to be elastically deformable within the housing chamber 107. The locking lance 111 engages with an annular part 35 of the shield unit 1 to prevent the shield unit 1 from disengaging from the housing chamber 107, and holds the shield unit 1 in the housing chamber 107.

The housing 103 is provided with a spacer housing part 113 to which the spacer 105 is assembled. The spacer housing part 113 has an opening on the lower surface side, which communicates with the housing chamber 107. On both sides of the spacer housing part 113, a temporarily engaged part 115 and a mainly engaged part 117 are respectively formed in such a way as to project outward. The temporarily engaged part 115 is disposed on the lower opening side with respect to the spacer housing part 113. The mainly engaged part 117 is disposed above the temporarily engaged part 115 with respect to the spacer housing part 113. The spacer 105 is assembled to the spacer housing part 113 from the opening side.

The spacer 105 is made of an insulating material such as a synthetic resin. The spacer 105 includes a pair of side walls 119, 119, and a connecting wall 121 connecting one end side of the pair of side walls 119, 119. The pair of side walls 119, 119 is elastically deformable in such a way that the connecting wall 121 side is a base end and the other end side is a free end. On the free end side of each of the pair of side walls 119, 119, an engagement part 123 projecting toward the direction in which the pair of side walls 119, 119 faces each other is provided. The engagement part 123 can engage with the temporarily engaged part 115 and the mainly engaged part 117 of the spacer housing part 113. Locking parts 125 are provided on the pair of side walls 119, 119 side of the connecting wall 121, and the locking parts 125 are formed of a member continuous with the connecting wall 121, and extend toward the engagement part 123 side.

The spacer 105 is assembled to the spacer housing part 113, and movable between the temporary locking position and the main locking position. At the temporary locking position of the spacer 105, the engaging part 123 is engaged with the temporarily engaged part 115 of the spacer housing part 113. At the temporary locking position of the spacer 105, the locking parts 125 do not interfere with the shield unit 1 housed in the housing chamber 107, and thus the shield unit 1 can be housed in the housing chamber 107. At the main locking position of the spacer 105, the engaging part 123 is engaged with the mainly engaged part 117 of the spacer housing part 113. At the main locking position of the spacer 105, the locking parts 125 are engaged with the annular part 35 of the shield unit 1 housed in the housing chamber 107. In addition to the locking lance 111 described above, the locking parts 125 are engaged with the annular part 35 of the shield unit 1, and thus the shield unit 1 can be doubly prevented from disengaging from the housing chamber 107. Accordingly, the shield unit 1 can be stably held in the housing chamber 107.

In the housing 103, a lock arm 127, which is elastically deformable in the height direction of the housing 103, is formed of a continuous member. The lock arm 127 is elastically deformable and extends along the fitting direction in such a way that the front side in the direction in which the connector 101 and the mating connector are fitted together is a base end, and the rear side in the direction in which the connector 101 and the mating connector are fitted together is a free end. A lock part 129 projecting upward is provided on the outer surface of the lock arm 127. The lock part 129 is engaged with a locked part (not illustrated) provided in the mating connector in a state in which the connector 101 and the mating connector are fitted together. By engaging the lock part 129 with the locked part, the engagement state between the connector 101 and the mating connector can be maintained. An operation part 131 is provided at the free end of the lock arm 127. The operation part 131 is pressed downward to elastically deform the lock arm 127 downward. When the lock arm 127 is elastically deformed downward, the engagement between the lock part 129 and the locked part is released. By releasing the engagement between the lock part 129 and the locked part, the engagement state between the connector 101 and the mating connector can be released.

The shield unit 1 is inserted into the housing 103 from an opening on one side of the housing chamber 107 in a state in which the spacer 105 is held in the temporary locking position. The locking lance 111 is engaged with the shield unit 1 inserted into the housing chamber 107. When moving the spacer 105 to the main locking position in a state in which the locking lance 111 is engaged with the shield unit 1, the locking parts 125 of the spacer 105 are engaged with the shield unit 1.

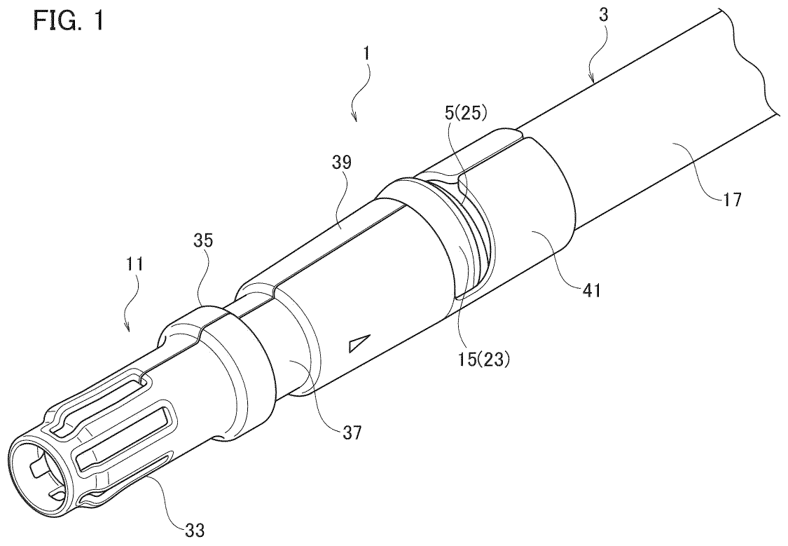

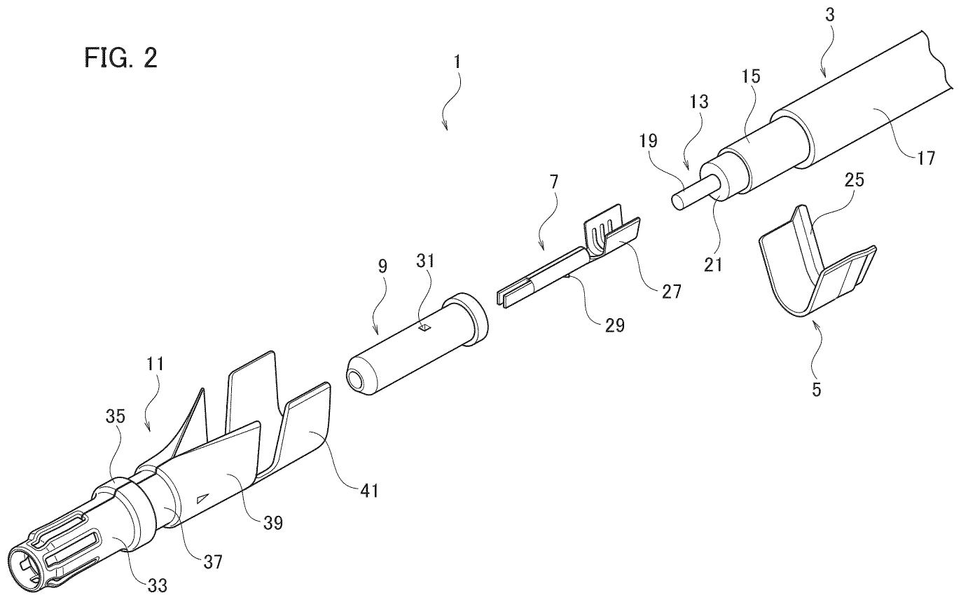

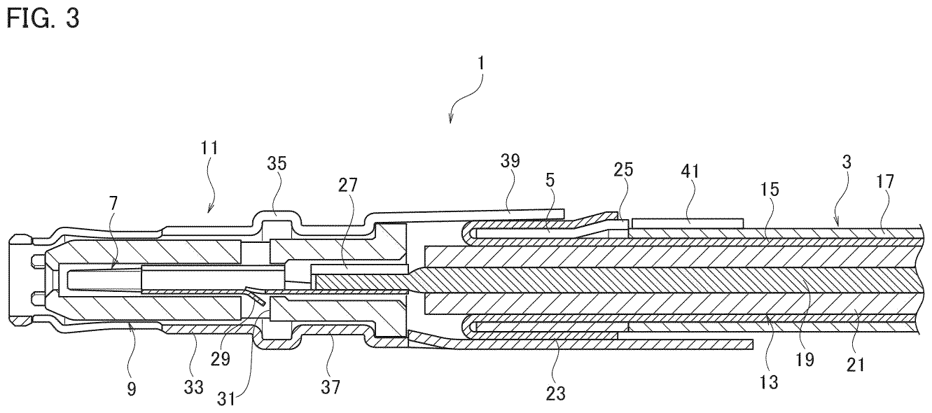

As illustrated in FIGS. 1 to 4, the shield unit 1 includes a coaxial electric wire 3, a sleeve 5, a terminal 7, an inner housing 9, and a shield member 11.

The coaxial electric wire 3 is pulled out to the outside of the housing 103 in a state in which the shield unit 1 is housed in the housing 103. The coaxial electric wire 3 includes an internal electric wire 13, an electric wire shield 15, and an outer skin 17. The internal electric wire 13 includes a core wire 19 in which a plurality of elementary wires made of a conductive material are twisted together, and an insulating coating 21 made of an insulating material and covering the outer periphery of the core wire 19. The core wire 19 may be a single wire. The internal electric wire 13 is electrically connected to, for example, a power source or a device. The electric wire shield 15 is formed of a braid in which a plurality of elementary wires made of a conductive material are weaved, and is disposed so as to cover an outer periphery of the internal electric wire 13. The electric wire shield 15 is not limited to a braid, and may be a metal foil or the like. The electric wire shield 15 is grounded. A metal foil is disposed between the internal electric wire 13 and the electric wire shield 15. The outer skin 17 is made of an insulating material, and is disposed so as to cover the outer periphery of the electric wire shield 15.

The sleeve 5 is made of a conductive material such as metal. The sleeve 5 is preliminarily formed into a U-shape by a plate having a predetermined width in the length direction of the coaxial electric wire 3. By peeling off the outer skin 17 of the coaxial electric wire 3 for a predetermined length and crimping the sleeve 5 to the outer periphery of the exposed wire shield 15, the sleeve 5 is formed into a cylindrical shape. On the outer periphery of the crimped sleeve 5, a folded-back part 23 of the electric wire shield 15 is disposed, which is folded back toward the outer skin 17. A shield crimping part 39 of the shield member 11 is crimped to the outer periphery of the folded-back part 23 where the sleeve 5 is positioned, and thus the electric wire shield 15 and the shield member 11 are electrically connected to each other.

An abutment part 25 is provided at the end part of the sleeve 5 on the coaxial electric wire 3 side. The abutment part 25 is formed so as to project outward from the outer periphery of the outer skin 17 of the coaxial electric wire 3 in a state in which the sleeve 5 is crimped to the outer periphery of the electric wire shield 15. At least, the end surface of the abutment part 25 on the coaxial electric wire 3 side is exposed from the folded-back part 23 of the electric wire shield 15. For this reason, the end surface of the abutment part 25 on the coaxial electric wire 3 side is disposed radially outward from the outer surface of the outer skin 17 of the coaxial electric wire 3 in a state in which the sleeve 5 is assembled to the coaxial electric wire 3. The coaxial electric wire 3 based on the member (the sleeve 5, the shield member 11, or the like) is the side opposite to the tip-end side of the terminal part of the internal electric wire 13 of the member (here, the sleeve 5), which is connected to the terminal part of the internal electric wire 13 of the coaxial electric wire 3, in the longitudinal direction of the coaxial electric wire 3.

In the coaxial electric wire 3 in which the sleeve 5 is disposed, the outer skin 17 is first peeled off for a predetermined length at the terminal part. Next, the sleeve 5 is crimped and assembled to the outer periphery of the exposed wire shield 15. Next, the outer periphery of the sleeve 5 is covered with the folded-back part 23 in which the electric wire shield 15 exposed from the sleeve 5 is folded back toward the outer skin 17. Next, the insulating coating 21 of the exposed internal electric wire 13 is peeled off for a predetermined length to expose the core wire 19 of the internal electric wire. In the coaxial electric wire 3 subjected to terminal processing, the terminal 7 is electrically connected to the exposed core wire 19 of the internal electric wire 13, and the shielding member 11 is electrically connected to the exposed wire shield 15.

The terminal 7 is made of a conductive material, and is a female terminal having a box-shaped connection part into which a tab-shaped connection part of the mating terminal can be inserted. The terminal 7 is electrically connected to the internal electric wire 13 by crimping a crimping part 27 including a pair of crimping pieces to the core wire 19 of the internal electric wire 13. The terminal 7 is housed in the inner housing 9, and is electrically connected to the mating terminal when the connector 101 and the mating connector are fitted together.

The inner housing 9 is made of an insulating material such as a synthetic resin, and is formed into a cylindrical shape with which it is possible to house the terminal 7. The inner housing 9 is provided with an engagement hole 31 with which an elastic piece 29 which is provided elastically deformable in the terminal 7 is engaged. Since the elastic piece 29 is engaged with the engagement hole 31, the terminal 7 is prevented from disengaging from the inner housing 9, thereby holding the terminal 7 in the inner housing 9. The inner housing 9 is housed in the shield member 11 to ensure insulation between the terminal 7 and the shield member 11.

The shield member 11 is made of a conductive material, and has a connection part 33 formed into a cylindrical shape which it is possible to house the inner housing 9. An annular part 35 projecting outward and formed continuously in the circumferential direction is provided on the outer periphery of the connection part 33. The annular part 35 is disposed in such a way that the annular part 35 can engage with (abut on) the engagement projection 109 of the housing chamber 107 in a state in which the shield unit 1 is housed in the housing 103. On the outer periphery of the connection part 33, a groove part 37 formed continuously in the circumferential direction is provided adjacent to the annular part 35. The groove part 37 is a part where the locking lance 111 of the housing chamber 107 and the locking parts 125 of the spacer 105 are positioned in a state in which the shield unit 1 is housed in the housing 103. Since the locking lance 111 and the locking parts 125 are positioned in the groove part 37, the locking lance 111 and the locking parts 125 are engaged with the annular part 35.

The shield member 11 has a shield crimping part 39 which is disposed on the coaxial electric wire 3 side from the connection part 33 and includes a pair of crimping pieces formed of a member continuous with the connection part 33. The shield crimping part 39 is crimped to the outer periphery of the folded-back part 23 of the electric wire shield 15 disposed on the outer periphery of the sleeve 5 of the coaxial electric wire 3. When the shield crimping part 39 is crimped to the outer periphery of the folded-back part 23, the electric wire shield 15 and the shield member 11 are electrically connected to each other.

Since the abutment part 25 of the sleeve 5 is exposed from the end part of the folded-back part 23 to the coaxial electric wire 3 side, the abutment part 25 is not disposed on the inner diameter side of the shield crimping part 39. For this reason, the abutment part 25 of the sleeve 5 is not involved in crimping the shield crimping part 39 to the folded-back part 23, thereby making it possible to ensure the electrical connection reliability between the electric wire shield 15 and the shield member 11. In addition, when the shield crimping part 39 is crimped, the abutment part 25 of the sleeve 5 is not deformed by the shield crimping part 39.

The shield member 11 has an outer skin crimping part 41 which is disposed on the coaxial electric wire 3 side from the shield crimping part 39 and includes a pair of crimping pieces formed of a member continuous with the shield crimping part 39. The outer skin crimping part 41 is crimped to the outer periphery of the outer skin 17 of the coaxial electric wire 3. When the outer skin fastening part 41 is crimped to the outer periphery of the outer skin 17, the shield member 11 is fixed to the coaxial electric wire 3.

In the shield member 11, the inner housing 9 for housing the terminal 7 is firstly housed within the connection part 33. Next, the shield crimping part 39 and the outer skin crimping part 41 are respectively crimped to the outer periphery of the folded-back part 23 of the electric wire shield 15 and the outer periphery of the outer skin 17, thereby forming the shield unit 1. The shield unit 1 is inserted into the housing chamber 107 of the housing 103 in which the spacer 105 is held in the temporary locking position, and is positioned in the housing chamber 107 when the annular part 35 engages with (abuts on) the engagement projection 109. At this time, the locking lance 111 is engaged with the annular part 35, thereby preventing the shield unit 1 from disengaging from the housing chamber 107. Thereafter, by moving the spacer 105 to the main locking position, the locking parts 125 are engaged with the annular part 35, and thus the shield unit 1 can be doubly prevented from disengaging from the housing chamber 107.

When the connector 101 housing the shield unit 1 is fitted with the mating connector, the terminal 7 and the mating terminal are electrically connected to each other. At this time, the connection part 33 of the shield member 11 is electrically connected to the mating shield member to form a shield circuit. The formation of the shield circuit prevents noise or the like from entering or leaking into the terminal 7 and the mating terminal.

In the shield unit 1 described above, the outer skin crimping part 41 of the shield member 11 is disposed to face the abutment part 25 of the sleeve 5 in the length direction of the coaxial electric wire 3. Specifically, the end surface of the outer skin crimping part 41 on the connection part 33 side is disposed to face the end surface of the abutment part 25 on the coaxial electric wire 3 side in the length direction of the coaxial electric wire 3. For this reason, for example, when a pulling force is applied to the coaxial electric wire 3, and the coaxial electric wire 3 and the shield member 11 move in the direction separated from each other with respect to the length direction of the coaxial electric wire 3, the outer skin crimping part 41 and the abutment part 25 abut with each other. When the outer skin crimping part 41 and the abutment part 25 abut with each other, the folded-back part 23 of the electric wire shield 15 and the shield crimping part 39 are suppressed from positional deviation. Accordingly, the electric wire shield 15 and the shield member 11 can be stably brought into contact with each other, thereby making it possible to ensure the electrical connection reliability between the electric wire shield 15 and the shield member 11.

The shield unit 1 described above includes the coaxial electric wire 3 including the internal electric wire 13, the electric wire shield 15 covering the outer periphery of the internal electric wire 13, and the outer skin 17 covering the outer periphery of the electric wire shield 15. The shield unit 1 also includes the sleeve 5 assembled to the terminal part where the electric wire shield 15 is exposed from the outer skin 17 of the coaxial electric wire 3, and having the outer periphery covered with the folded-back part 23 of the electric wire shield 15 which is folded back. The shield unit 1 also includes the shield member 11 having the shield crimping part 39 which is crimped to the outer periphery of the folded-back part 23 of the electric wire shield 15. Further, the shield member 11 is provided with the outer skin crimping part 41 which is disposed on the coaxial electric wire 3 side from the shield crimping part 39, and crimped to the outer periphery of the outer skin 17 of the coaxial electric wire 3. Further, the sleeve 5 is provided with the abutment part 25 which abuts on the outer skin crimping part 41 when the coaxial electric wire 3 and the shield member 11 move in the direction separated from each other.

The abutment part 25 abuts on the outer skin crimping part 41 when the coaxial electric wire 3 and the shield member 11 move in the direction separated from each other. For this reason, the folded-back part 23 of the electric wire shield 15 and the shield crimping part 39 are suppressed from positional deviation.

Accordingly, in the shield unit 1 described above, the electric wire shield 15 and the shield member 11 can be stably brought into contact with each other, thereby making it possible to ensure the electrical connection reliability between the electric wire shield 15 and the shield member 11.

Further, the abutment part 25 projects outward in the radial direction of the coaxial electric wire 3. For this reason, a large amount of abutment of the abutment part 25 can be obtained with respect to the outer skin crimping part 41 crimped to the outer skin 17, thereby making it possible to stabilize the abutment between the abutment part 25 and the outer skin crimping part 41.

Further, the abutment part 25 is exposed from the folded-back part 23 of the electric wire shield 15. For this reason, the abutment part 25 is not involved in crimping the shield crimping part 39 to the folded-back part 23, thereby making it possible to ensure the electrical connection reliability between the electric wire shield 15 and the shield member 11. In addition, when the shield crimping part 39 is crimped, the abutment part 25 of the sleeve 5 is not deformed by the shield crimping part 39.

Although the present embodiment has been described above, the present embodiment is not limited thereto, and various modifications are possible within a scope of the gist of the present embodiment.

For example, although the sleeve according to the present embodiment is formed into a shape in which a portion in the circumferential direction is cut out; however, the present invention is not limited thereto. For example, the sleeve may be formed into an annular shape continuous in the circumferential direction. In addition, although the sleeve is assembled to the outer periphery of the electric wire shield exposed from the outer skin, and the folded-back part is disposed thereon; however, the present invention is not limited thereto. For example, the sleeve may be assembled to the outer periphery of the outer skin, and the folded-back part of the electric wire shield may be disposed thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A shield unit, comprising:
a coaxial electric wire including an internal electric wire, an electric wire shield covering an outer periphery of the internal electric wire, and an outer skin covering an outer periphery of the electric wire shield;
a sleeve assembled to a terminal part where the electric wire shield is exposed from the outer skin of the coaxial electric wire, and having an outer periphery covered with a folded-back part of the electric wire shield which is folded back; and
a shield member having a shield crimping part which is crimped to an outer periphery of the folded-back part of the electric wire shield, wherein
the shield member is provided with an outer skin crimping part which is disposed on a coaxial electric wire side from the shield crimping part, and crimped to an outer periphery of the outer skin of the coaxial electric wire,
the sleeve is provided with an abutment part which abuts on the outer skin crimping part when the coaxial electric wire and the shield member move in a direction separated from each other,
the abutment part is not disposed on an inner diameter side of the shield crimping part, and
an end surface of the outer skin crimping part on the shield crimping part side is disposed to face an end surface of the abutment part on the coaxial electric wire side in a length direction of the coaxial electric wire.

2. The shield unit according to claim 1, wherein
the abutment part projects outward in a radial direction of the coaxial electric wire.

3. The shield unit according to claim 1, wherein
the abutment part is exposed from the folded-back part of the electric wire shield.
